(19) United States
(12) Patent Application Publication
(10) Pub. No.: US 2026/0128000 A1
(43) Pub. Date: May 7, 2026

(54) PIXEL, DISPLAY DEVICE INCLUDING THE PIXEL, AND ELECTRONIC DEVICE INCLUDING THE DISPLAY DEVICE

(71) Applicant: Samsung Display Co., LTD., Yongin-si (KR)

(72) Inventors: JUNKI JEONG, Yongin-si (KR); JUNGHWAN HWANG, Yongin-si (KR); YOUNGWAN SEO, Yongin-si (KR)

(21) Appl. No.: 19/284,017

(22) Filed: Jul. 29, 2025

(30) Foreign Application Priority Data
Nov. 1, 2024 (KR) 10-2024-0153592
May 19, 2025 (KR) 10-2025-0064299

(51) Int. Cl. G09G 3/32

(52) U.S. Cl. CPC G09G 3/32; G09G 2300/0426; G09G 2310/061; G09G 2310/08; G09G 2330/021

(57) ABSTRACT

A pixel includes a first transistor including a gate connected to a first node, a first terminal, and a second terminal connected to the second node, a third transistor which connects a sensing line to the second node, a fourth transistor which connects a power line to the first terminal of the first transistor, a first capacitor, and a light-emitting element. A frame period includes an active period and a blank period. The blank period includes a sensing compensation period in which a threshold voltage of the first transistor is stored in the first capacitor, a sensing addressing period in which a sensing data voltage is applied to the first node, and a sensing period in which a sensing current corresponding to the sensing data voltage flows from the power line to the sensing line.

This application claims priority to Korean Patent Application No. 10-2024-0153592, filed on Nov. 1, 2024, and Korean Patent Application No. 10-2025-0064299, filed on May 19, 2025, and all the benefits accruing therefrom under 35 U.S.C. § 119, the contents of which in their entirety are herein incorporated by reference.

### BACKGROUND

### 1. Field

Embodiments relate to a display device. More particularly, embodiments relate to a pixel that emits light, a display device including the pixel, and an electronic device including the display device.

### 2. Description of the Related Art

A display device may include pixels that emit light. Each of the pixels may include a driving transistor that generates a driving current and a light-emitting element that emits light with a luminance corresponding to the driving current.

As usage time of the display device increases, the driving transistor and the light-emitting element may deteriorate. Accordingly, the degree of deterioration of the driving transistor and/or the degree of deterioration of the light-emitting element may be measured by sensing a current flowing through the pixel.

### SUMMARY

Embodiments provide a pixel in which a sensing current, which is based on temperature (e.g., only on temperature), flows.

Embodiments provide a display device in which a temperature of a display panel is accurately estimated and an electronic device including the display device.

A pixel according to embodiments includes a first transistor including a gate connected to a first node, a first terminal, and a second terminal connected to a second node, a second transistor which connects a data line to the first node in response to a write gate signal, a third transistor which connects a sensing line to the second node in response to an initialization gate signal, a fourth transistor which connects a power line to the first terminal of the first transistor in response to an emission signal, wherein the power line transmits a first power voltage, a first capacitor connected between the first node and the second node, and a light-emitting element including a first terminal connected to the second node and a second terminal which receives a second power voltage. A frame period includes an active period and a blank period following the active period. The blank period includes a sensing compensation period in which a threshold voltage of the first transistor is stored in the first capacitor, a sensing addressing period in which a sensing data voltage is applied to the first node, wherein the sensing addressing period is after the sensing compensation period, and a sensing period in which a sensing current corresponding to the sensing data voltage flows from the power line to the sensing line, wherein the sensing period is after the sensing addressing period.

In an embodiment, the blank period may further include a sensing initialization period in which a reference voltage is applied to the first node and an initialization voltage is applied to the second node, wherein the sensing initialization period is before the sensing compensation period.

In an embodiment, the blank period may further include a first sensing bypass period in which an initialization voltage is applied to the second node, wherein the first sensing bypass period is before the sensing period.

In an embodiment, the blank period may further include a second sensing bypass period in which the initialization voltage is applied to the second node, wherein the second sensing bypass period is after the sensing period.

In an embodiment, the pixel may further include a second capacitor including a first terminal connected to the second node and a second terminal which receives a constant voltage.

In an embodiment, the constant voltage may be one of an initialization voltage and the first power voltage.

In an embodiment, the second power voltage may be a constant voltage having a voltage level lower than a voltage level of the first power voltage.

In an embodiment, the second power voltage may have a low voltage level in the active period, and may have a high voltage level higher than the low voltage level in the blank period.

In an embodiment, the active period may include an initialization period in which a reference voltage is applied to the first node and an initialization voltage is applied to the second node, a compensation period in which the threshold voltage of the first transistor is stored in the first capacitor, wherein the compensation period is after the initialization period, an addressing period in which a data voltage is applied to the first node, wherein the addressing period is after the compensation period, a bypass period in which the initialization voltage is applied to the second node, wherein the bypass period is after the addressing period, and an emission period in which a sensing current corresponding to the data voltage flows through the light-emitting element, wherein the emission period is after the bypass period.

A display device according to embodiments includes a display panel including pixels, a gate driver which provides a write gate signal and an initialization gate signal to each of the pixels, an emission driver which provides an emission signal to each of the pixels, a data driver connected to each of the pixels through a data line, and a sensing circuit connected to each of the pixels through a sensing line. Each of the pixels includes a first transistor including a gate connected to a first node, a first terminal, and a second terminal connected to a second node, a second transistor which connects the data line to the first node in response to the write gate signal, a third transistor which connects the sensing line to the second node in response to the initialization gate signal, a fourth transistor which connects a power line to the first terminal of the first transistor in response to the emission signal, wherein the power line transmits a first power voltage, a first capacitor connected between the first node and the second node, and a light-emitting element including a first terminal connected to the second node and a second terminal which receives a second power voltage. A frame period includes an active period and a blank period following the active period. The blank period includes a sensing compensation period in which a threshold voltage of the first transistor is stored in the first capacitor, a sensing addressing period in which a sensing data voltage is applied to the first node, wherein the sensing addressing period is after the sensing compensation period, and a sensing period in which a sensing current corresponding to the sensing data voltage flows from the power line to the sensing line, wherein the sensing period is after the sensing addressing period.

In an embodiment, the display panel may include a plurality of vertical blocks each including a plurality of pixel rows. The gate driver may provide write gate signals respectively corresponding to the vertical blocks in the sensing addressing period.

In an embodiment, the data driver may provide the sensing data voltage corresponding to a white grayscale to each of pixel columns overlapping a sensing area, and may provide the sensing data voltage corresponding to a black grayscale to each of pixel columns not overlapping the sensing area.

In an embodiment, the blank period may further include a sensing initialization period in which a reference voltage is applied to the first node and an initialization voltage is applied to the second node, wherein the sensing initialization period is before the sensing compensation period.

In an embodiment, the blank period may further include a first sensing bypass period in which an initialization voltage is applied to the second node, wherein the first sensing bypass period is before the sensing period.

In an embodiment, the blank period may further include a second sensing bypass period in which the initialization voltage is applied to the second node, wherein the second sensing bypass period is after the sensing period.

In an embodiment, each of the pixels may further include a second capacitor including a first terminal connected to the second node and a second terminal which receives a constant voltage.

In an embodiment, the second power voltage may be a constant voltage having a voltage level lower than a voltage level of the first power voltage.

In an embodiment, the second power voltage may have a low voltage level in the active period, and may have a high voltage level higher than the low voltage level in the blank period.

In an embodiment, the active period may include an initialization period in which a reference voltage is applied to the first node and an initialization voltage is applied to the second node, a compensation period in which the threshold voltage of the first transistor is stored in the first capacitor, wherein the compensation period is after the initialization period, an addressing period in which a data voltage is applied to the first node, wherein the addressing period is after the compensation period, a bypass period in which the initialization voltage is applied to the second node, wherein the bypass period is after the addressing period, and an emission period in which a sensing current corresponding to the data voltage flows through the light-emitting element, wherein the emission period is after the bypass period.

An electronic device according to embodiments includes a processor, a memory connected to the processor, a power module connected to the processor, and a display device which receives input image data from the processor, and displays an image corresponding to the input image data. The display device includes a display panel including pixels, a gate driver which provides a write gate signal and an initialization gate signal to each of the pixels, an emission driver which provides an emission signal to each of the pixels, a data driver connected to each of the pixels through a data line, and a sensing circuit connected to each of the pixels through a sensing line. Each of the pixels includes a first transistor including a gate connected to a first node, a first terminal, and a second terminal connected to a second node, a second transistor which connects the data line to the first node in response to the write gate signal, a third transistor which connects the sensing line to the second node in response to the initialization gate signal, a fourth transistor which connects a power line to the first terminal of the first transistor in response to the emission signal, wherein the power line transmits a first power voltage, a first capacitor connected between the first node and the second node, and a light-emitting element including a first terminal connected to the second node and a second terminal which receives a second power voltage. A frame period includes an active period and a blank period following the active period. The blank period includes a sensing compensation period in which a threshold voltage of the first transistor is stored in the first capacitor, a sensing addressing period in which a sensing data voltage is applied to the first node, wherein the sensing addressing period is after the sensing compensation period, and a sensing period in which a sensing current corresponding to the sensing data voltage flows from the power line to the sensing line, wherein the sensing period is after the sensing addressing period.

In the pixel according to the embodiments, the sensing current in which a deviation of the threshold voltage of the first transistor is compensated flows through the sensing line in the blank period, such that the sensing current may be based on temperature (e.g., only on temperature) of an area in which the pixel including the first transistor is positioned.

In the display device and the electronic device according to the embodiments, the temperature of the sensing area of the display panel may be accurately estimated through the sensing current.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to an embodiment.

FIG. 2 is a circuit diagram illustrating an example of a pixel of FIG. 1.

FIG. 3 is a timing diagram illustrating voltages and signals provided to pixels of FIG. 1 in an active period.

FIG. 4 is a timing diagram illustrating voltages and signals provided to the pixels of FIG. 1 in a blank period.

FIG. 5 is a diagram illustrating a display panel of FIG. 1.

FIG. 6 is a diagram for describing a sensing initialization period of FIG. 4.

FIG. 7 is a diagram for describing a sensing compensation period of FIG. 4.

FIG. 8 is a diagram for describing a sensing addressing period of FIG. 4.

FIG. 9 is a diagram illustrating an example of a sensing area of the display panel of FIG. 5.

FIG. 10 is a diagram illustrating an example of the sensing area of the display panel of FIG. 5.

FIG. 11 is a diagram illustrating an example of the sensing area of the display panel of FIG. 5.

FIG. 12 is a diagram for describing a first sensing bypass period of FIG. 4.

FIG. 13 is a diagram for describing a sensing period of FIG. 4.

FIG. 14 is a graph for describing a sensing current of FIG. 13.

FIG. 15 is a diagram for describing a second sensing bypass period of FIG. 4.

FIG. 16 is a timing diagram illustrating voltages and signals provided to the pixels of FIG. 1 in a blank period.

FIG. 17 is a block diagram illustrating an electronic device according to an embodiment.

FIG. 18 is a diagram illustrating electronic devices according to embodiments.

### DETAILED DESCRIPTION

Hereinafter, a pixel, a display device, and an electronic device according to embodiments of the present disclosure will be described in more detail with reference to the accompanying drawings. The same or similar reference numerals will be used for the same elements in the accompanying drawings.

Embodiments supported by the present disclosure will now be described more fully hereinafter with reference to the accompanying drawings, in which one or more example embodiments are illustrated. Aspects supported by the present disclosure may, however, be embodied in different forms and should not be construed as limited to the embodiments set forth herein. Rather, these example embodiments are provided so that this disclosure will be thorough and complete, and will fully convey the scope of example aspects of the invention to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, comp

The terms “about” or “approximately” as used herein are inclusive of the stated value and include a suitable range of deviation for the particular value as determined by one of ordinary skill in the art, considering the measurement in question and the error associated with measurement of the particular quantity. The term “about” can mean within one or more standard deviations, or within ±30%, 20%, 10%, 5% of the stated value, for example.

The term “substantially,” as used herein, means approximately or actually. The term “substantially equal” means approximately or actually equal. The term “substantially the same” means approximately or actually the same. The term “substantially identical” means approximately or actually identical. The term “substantially perpendicular” means approximately or actually perpendicular.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

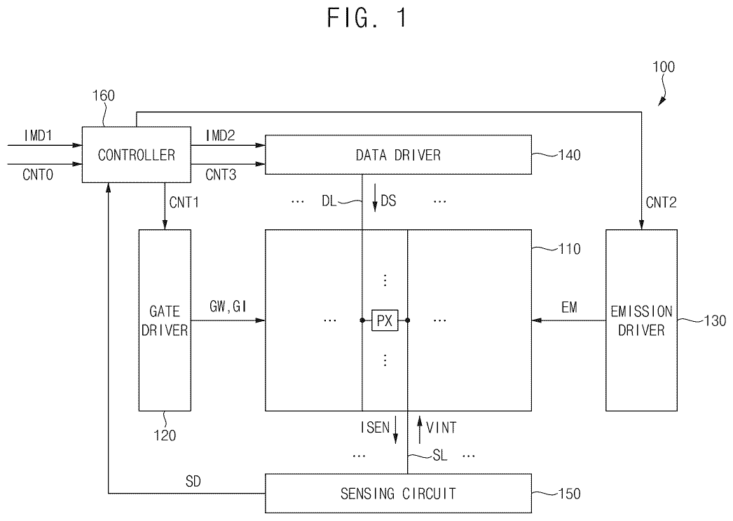

FIG. 1 is a block diagram illustrating a display device 100 according to an embodiment.

Referring to FIG. 1, the display device 100 may include a display panel 110, a gate driver 120, an emission driver 130, a data driver 140, a sensing circuit 150, and a controller 160.

The display panel 110 may include pixels PX, gate lines, emission lines, data lines DL, and sensing lines SL. The pixels PX may be connected to the gate lines, the emission lines, the data lines DL, and the sensing lines SL.

The display panel 110 may include a display area that displays an image and a non-display area surrounding at least a portion of the display area. The pixels PX may be positioned in the display area.

The gate driver 120 may be connected to the pixels PX through the gate lines. The gate driver 120 may provide a write gate signal GW and an initialization gate signal GI to each of the pixels PX. The gate driver 120 may generate the write gate signal GW and the initialization gate signal GI based on a first control signal CNT1. The first control signal CNT1 may include a gate clock signal, a gate start signal, or the like. In an embodiment, the gate driver 120 may be formed or mounted in the non-display area of the display panel 110.

The emission driver 130 may be connected to the pixels PX through the emission lines. The emission driver 130 may provide an emission signal EM to each of the pixels PX. The emission driver 130 may generate the emission signal EM based on a second control signal CNT2. The second control signal CNT2 may include an emission clock signal, an emission start signal, or the like. In an embodiment, the emission driver 130 may be formed or mounted in the non-display area of the display panel 110.

The data driver 140 may be connected to the pixels PX through the data lines DL. The data driver 140 may provide a data signal DS to each of the pixels PX. The data driver 140 may generate the data signal DS based on output image data IMD2 and a third control signal CNT3. The data driver 140 may convert the output image data IMD2 in a digital format into the data signal DS in an analog format. The third control signal CNT3 may include a data clock signal, a load signal, an output data enable signal, or the like. In an embodiment, the data driver 140 may be implemented as an integrated circuit IC.

The sensing circuit 150 may be connected to the pixels PX through the sensing lines SL. The sensing circuit 150 may provide an initialization voltage VINT to the pixels PX. In an embodiment, the sensing circuit 150 may be implemented as a single integrated circuit together with the data driver 140. In another embodiment, the sensing circuit 150 may be implemented as a separate integrated circuit from the data driver 140.

The sensing circuit 150 may receive sensing current ISEN from the pixels PX. The sensing circuit 150 may provide sensing data SD to the controller 160. The sensing circuit 150 may generate the sensing data SD based on the sensing current ISEN.

The controller 160 may control the gate driver 120, the emission driver 130, the data driver 140, and the sensing circuit 150. The controller 160 may provide the first control signal CNT1 to the gate driver 120, may provide the second control signal CNT2 to the emission driver 130, and may provide the output image data IMD2 and the third control signal CNT3 to the data driver 140. The controller 160 may generate the output image data IMD2, the first control signal CNT1, the second control signal CNT2, and the third control signal CNT3 based on input image data IMD1 and a control signal CNT0. The controller 160 may convert the input image data IMD1 into the output image data IMD2. The control signal CNT0 may include a master clock signal, a vertical synchronization signal, a horizontal synchronization signal, an input data enable signal, or the like. In an embodiment, the controller 160 may be implemented as a single integrated circuit together with the data driver 140. In another embodiment, the controller 160 may be implemented as a separate integrated circuit from the data driver 140.

The controller 160 may receive the sensing data SD from the sensing circuit 150. The controller 160 may estimate temperature of a sensing area of the display panel 110 based on the sensing data SD.

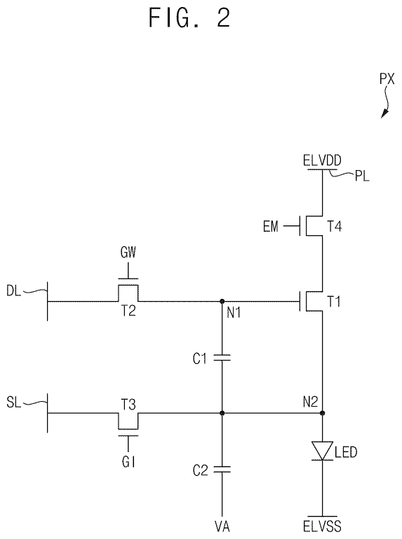

FIG. 2 is a circuit diagram illustrating an example of the pixel PX of FIG. 1.

Referring to FIGS. 1 and 2, the pixel PX may receive the write gate signal GW, the initialization gate signal GI, the emission signal EM, the data signal DS, the initialization voltage VINT, a first power voltage ELVDD, a second power voltage ELVSS, and a constant voltage VA. The pixel PX may include a first transistor T1, a second transistor T2, a third transistor T3, a fourth transistor T4, a first capacitor C1, a second capacitor C2, and a light-emitting element LED.

The first transistor T1 may include a gate connected to a first node N1, a first terminal, and a second terminal connected to a second node N2. The first terminal of the first transistor T1 may be one of a source and a drain of the first transistor T1, and the second terminal of the first transistor T1 may be the other one of the source and the drain of the first transistor T1. The first transistor T1 may be referred to as a driving transistor.

The second transistor T2 may connect the data line DL to the first node N1 in response to the write gate signal GW. The second transistor T2 may include a gate that receives the write gate signal GW, a first terminal connected to the data line DL, and a second terminal connected to the first node N1. The first terminal of the second transistor T2 may be one of a source and a drain of the second transistor T2, and the second terminal of the second transistor T2 may be the other one of the source and the drain of the second transistor T2. The second transistor T2 may be referred to as a write transistor.

The third transistor T3 may connect the sensing line SL to the second node N2 in response to the initialization gate signal GI. The third transistor T3 may include a gate that receives the initialization gate signal GI, a first terminal connected to the sensing line SL, and a second terminal connected to the second node N2. The first terminal of the third transistor T3 may be one of a source and a drain of the third transistor T3, and the second terminal of the third transistor T3 may be the other one of the source and the drain of the third transistor T3. The third transistor T3 may be referred to as a sensing transistor or an initialization transistor.

The fourth transistor T4 may connect a power line PL to the first terminal of the first transistor T1 in response to the emission signal EM. The power line PL may transmit the first power voltage ELVDD. The fourth transistor T4 may include a gate that receives the emission signal EM, a first terminal connected to the power line PL, and a second terminal connected to the first terminal of the first transistor T1. The first terminal of the fourth transistor T4 may be one of a source and a drain of the fourth transistor T4, and the second terminal of the fourth transistor T4 may be the other one of the source and the drain of the fourth transistor T4. The fourth transistor T4 may be referred to as an emission transistor.

In an embodiment, each of the first transistor T1, the second transistor T2, the third transistor T3, and the fourth transistor T4 may be an n-type transistor (e.g., an NMOS transistor). In another embodiment, at least one of the first transistor T1, the second transistor T2, the third transistor T3, and the fourth transistor T4 may be a p-type transistor (e.g., a PMOS transistor).

The first capacitor C1 may be connected between the first node N1 and the second node N2. The first capacitor C1 may include a first terminal connected to the first node N1 and a second terminal connected to the second node N2. The first capacitor C1 may store a voltage corresponding to a voltage difference between the first node N1 and the second node N2. The first capacitor C1 may be referred to as a storage capacitor.

The second capacitor C2 may include a first terminal connected to the second node N2 and a second terminal that receives the constant voltage VA. In an embodiment, the constant voltage VA may be one of the initialization voltage VINT and the first power voltage ELVDD. The second capacitor C2 may maintain a voltage of the second node N2. The second capacitor C2 may be referred to as a holding capacitor.

Although FIG. 2 illustrates an embodiment in which the pixel PX includes four transistors T1, T2, T3, and T4 and two capacitors C1 and C2, embodiments of the present disclosure are not limited thereto. In another embodiment, the pixel PX may include two, three, or five or more transistors and/or one or three or more capacitors.

The light-emitting element LED may include a first terminal connected to the second node N2 and a second terminal that receives the second power voltage ELVSS. In an embodiment, the first terminal of the light-emitting element LED may be an anode of the light-emitting element LED, and the second terminal of the light-emitting element LED may be a cathode of the light-emitting element LED. In an embodiment, the light-emitting element LED may be one of an organic light-emitting diode, an inorganic light-emitting diode, and a quantum dot light-emitting diode.

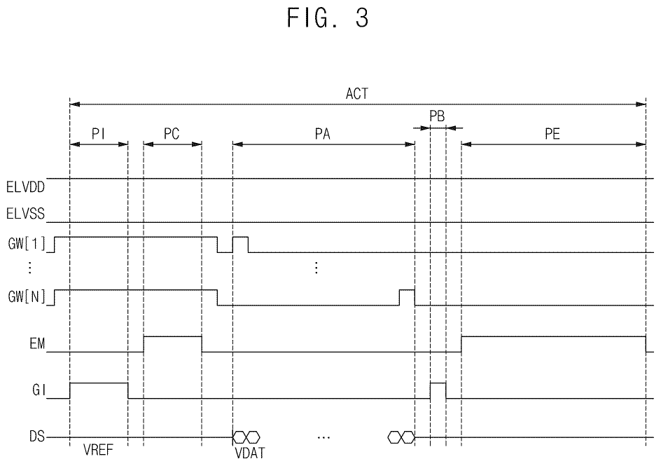

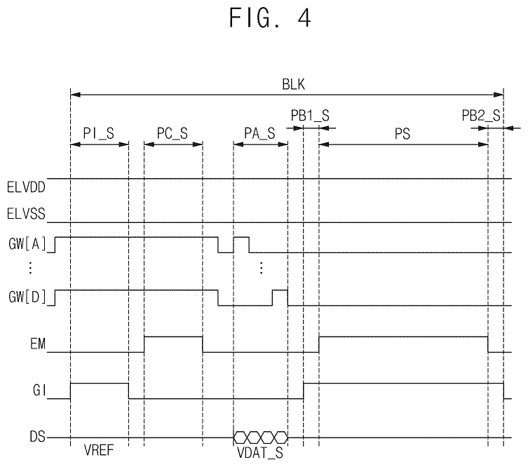

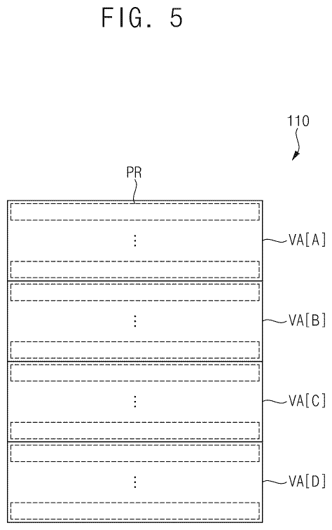

FIG. 3 is a timing diagram illustrating voltages and signals provided to the pixels PX of FIG. 1 in an active period ACT. FIG. 4 is a timing diagram illustrating voltages and signals provided to the pixels PX of FIG. 1 in a blank period BLK. FIG. 5 is a diagram illustrating the display panel 110 of FIG. 1.

Referring to FIGS. 1 to 5, a frame period may include the active period ACT and the blank period BLK following the active period ACT. One active period ACT may be a period in which the display device 100 displays one image frame. The blank period BLK may be positioned between adjacent active periods ACT. In an example in which a first frame period includes a first active period and a first blank period, the first blank period may be positioned between the first active period and a second active period of a second frame period following the first frame period.

The active period ACT may include an initialization period PI, a compensation period PC, an addressing period PA, a bypass period PB, and an emission period PE. The blank period BLK may include a sensing initialization period PI_S, a sensing compensation period PC_S, a sensing addressing period PA_S, a first sensing bypass period PB1_S, a sensing period PS, and a second sensing bypass period PB2_S.

The first power voltage ELVDD may be a constant voltage. In an embodiment, the second power voltage ELVSS may be a constant voltage having a voltage level lower than a voltage level of the first power voltage ELVDD.

The emission signal EM and the initialization gate signal GI may be commonly provided to first to N^{th} (N is a natural number greater than or equal to 2) pixel rows PR of the display panel 110. In the active period ACT, the write gate signals GW[1], . . . , GW[N] may be provided to the first to N^{th} pixel rows PR, respectively. In the blank period BLK, write gate signals GW[A], . . . , GW[D] may be provided to each of a plurality of vertical blocks VB[A], VB[B], VB[C], and VB[D] of the display panel 110. Each of the vertical blocks VB[A], VB[B], VB[C], and VB[D] may include a plurality of pixel rows PR.

Although FIG. 5 illustrates an embodiment in which the display panel 110 includes four vertical blocks VB[A], VB[B], VB[C], and VB[D], embodiments of the present disclosure are not limited thereto. In another embodiment, the display panel 110 may include two, three, or five or more vertical blocks.

The write gate signals GW[1], . . . , GW[N] may have a turn-on voltage level (e.g., a high voltage level) in the initialization period PI and the compensation period PC, may include a pulse having the turn-on voltage level in the addressing period PA, and may have a turn-off voltage level (e.g., a low voltage level) in the bypass period PB and the emission period PE. In an embodiment, the pulses of the write gate signals GW[1], . . . , GW[N] positioned in the addressing period PA may have a width corresponding to one horizontal time period, and may be sequentially shifted by one horizontal time period.

The write gate signals GW[A], . . . , GW[D] may have the turn-on voltage level in the sensing initialization period PI_S and the sensing compensation period PC_S, may include a pulse having the turn-on voltage level in the sensing addressing period PA_S, and may have the turn-off voltage level in the first sensing bypass period PB1_S, the sensing period PS, and the second sensing bypass period PB2_S. In an embodiment, the pulses of the write gate signals GW[A], . . . , GW[D] positioned in the sensing addressing period PA_S may have a width corresponding to one horizontal time period, and may be sequentially shifted by one horizontal time period.

The emission signal EM may have the turn-off voltage level in the initialization period PI, the addressing period PA, the bypass period PB, the sensing initialization period PI S, the sensing addressing period PA_S, the first sensing bypass period PB1_S, and the second sensing bypass period PB2_S, and may have the turn-on voltage level in the compensation period PC, the emission period PE, the sensing compensation period PC_S, and the sensing period PS. The initialization gate signal GI may have the turn-on voltage level in the initialization period PI, the bypass period PB, the sensing initialization period PI S, the first sensing bypass period PB1_S, the sensing period PS, and the second sensing bypass period PB2_S, and may have the turn-off voltage level in the compensation period PC, the addressing period PA, the emission period PE, the sensing compensation period PC_S, and the sensing addressing period PA_S.

The data signal DS may have a reference voltage VREF in the initialization period PI, the compensation period PC, the bypass period PB, the emission period PE, the sensing initialization period PI_S, the sensing compensation period PC_S, the first sensing bypass period PB1_S, the sensing period PS, and the second sensing bypass period PB2_S, may have a data voltage VDAT in the addressing period PA, and may have a sensing data voltage VDAT_S in the sensing addressing period PA_S.

In the initialization period PI, the reference voltage VREF may be applied to the first node N1, and the initialization voltage VINT may be applied to the second node N2. The reference voltage VREF may be transmitted from the data line DL to the first node N1 through the second transistor T2 turned on in response to the write gate signal GW, and the initialization voltage VINT may be transmitted from the sensing line SL to the second node N2 through the third transistor T3 turned on in response to the initialization gate signal GI.

In the compensation period PC, a threshold voltage of the first transistor T1 may be stored in the first capacitor C1. A current may flow from the power line PL to the second node N2 through the fourth transistor T4 turned on in response to the emission signal EM and the first transistor T1, and a voltage of the second node N2 may increase from the initialization voltage VINT to a value obtained by subtracting the threshold voltage of the first transistor T1 from the reference voltage VREF.

In the addressing period PA, the data voltage VDAT may be applied to the first node N1. The data voltage VDAT may be transmitted from the data line DL to the first node N1 through the second transistor T2 turned on in response to the write gate signal GW.

In the bypass period PB, the initialization voltage VINT may be applied to the second node N2. The initialization voltage VINT may be transmitted from the sensing line SL to the second node N2 through the third transistor T3 turned on in response to the initialization gate signal GI. Accordingly, charges stored in the first terminal of the light-emitting element LED may be discharged to the sensing line SL through the third transistor T3.

In the emission period PE, a driving current corresponding to the data voltage VDAT may flow through the light-emitting element LED. The first transistor T1 may generate the driving current corresponding to a value obtained by subtracting the threshold voltage of the first transistor T1 from a voltage difference between the first node N1 and the second node N2 stored in the first capacitor C1, and the driving current may flow from the power line PL to a line that transmits the second power voltage ELVSS through the fourth transistor T4 turned on in response to the emission signal EM, the first transistor T1, and the light-emitting element LED, and the light-emitting element LED may emit light with a luminance corresponding to the driving current.

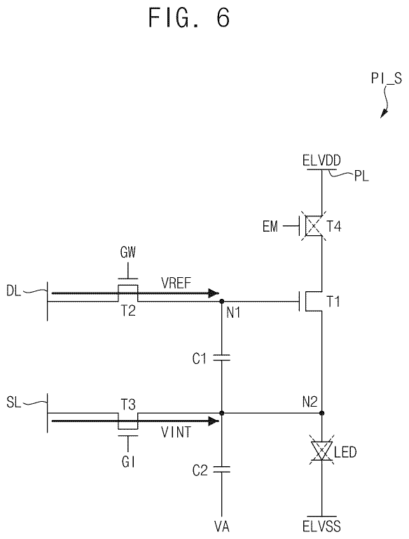

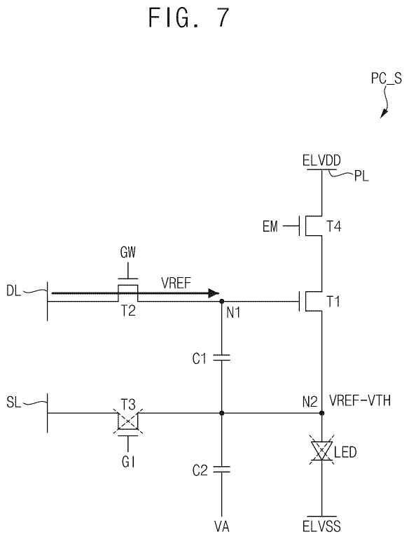

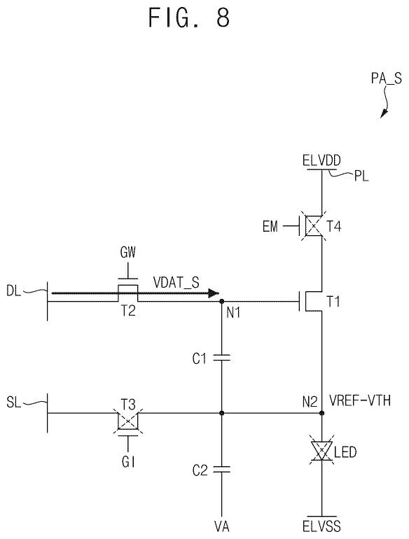

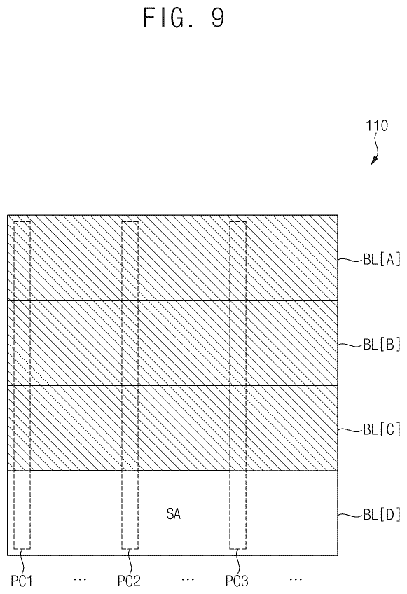

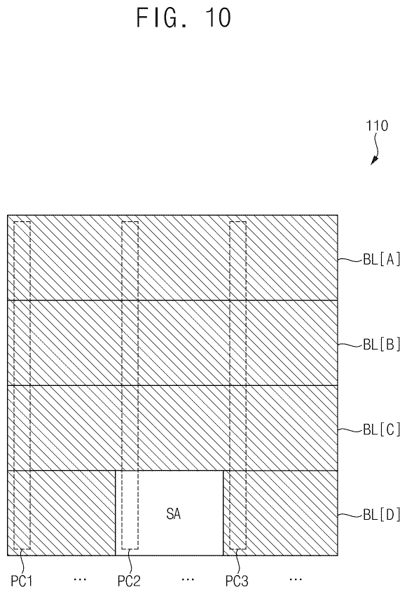

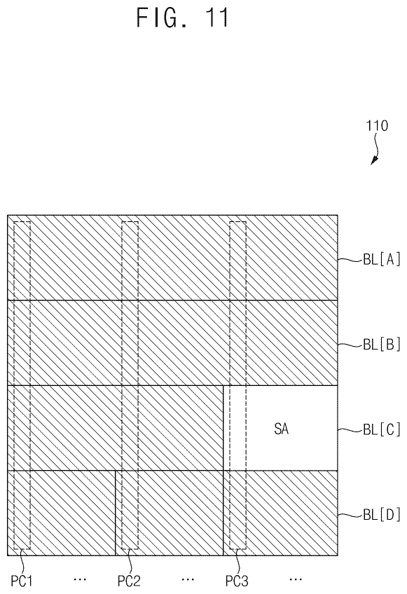

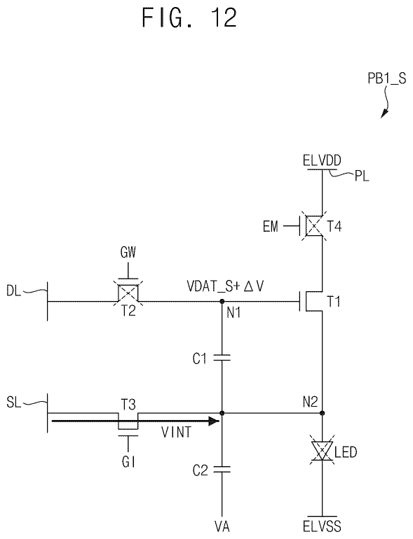

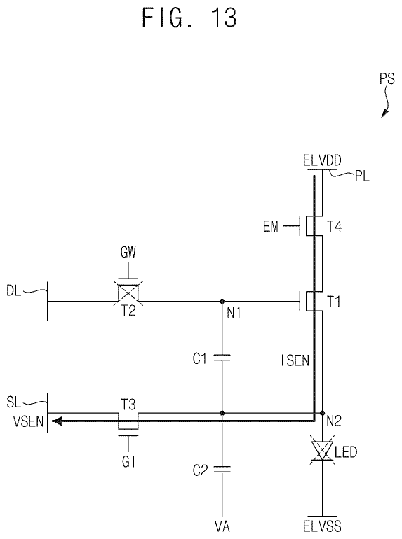

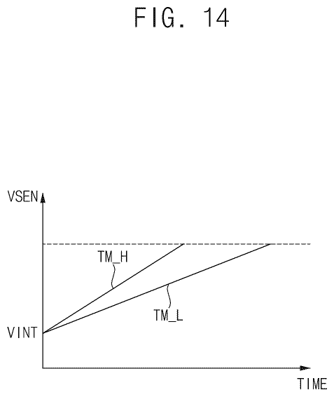

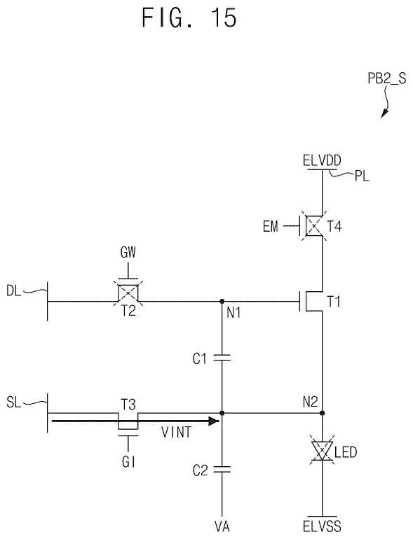

FIG. 6 is a diagram for describing the sensing initialization period PI_S of FIG. 4. FIG. 7 is a diagram for describing the sensing compensation period PC_S of FIG. 4. FIG. 8 is a diagram for describing the sensing addressing period PS_S of FIG. 4. FIG. 9 is a diagram illustrating an example of the sensing area SA of the display panel 110 of FIG. 5. FIG. 10 is a diagram illustrating an example of the sensing area SA of the display panel 110 of FIG. 5. FIG. 11 is a diagram illustrating an example of the sensing area SA of the display panel 110 of FIG. 5. FIG. 12 is a diagram for describing the first sensing bypass period PB1_S of FIG. 4. FIG. 13 is a diagram for describing the sensing period PS of FIG. 4. FIG. 14 is a graph for describing a sensing current ISEN of FIG. 13. FIG. 15 is a diagram for describing the second sensing bypass period PB2_S of FIG. 4.

Referring to FIGS. 4 and 6, in the sensing initialization period PI S, the reference voltage VREF may be applied to the first node N1, and the initialization voltage VINT may be applied to the second node N2. The reference voltage VREF may be transmitted from the data line DL to the first node N1 through the second transistor T2 turned on in response to the write gate signal GW, and the initialization voltage VINT may be transmitted from the sensing line SL to the second node N2 through the third transistor T3 turned on in response to the initialization gate signal GI.

Referring to FIGS. 4 and 7, in the sensing compensation period PC_S, the threshold voltage VTH of the first transistor T1 may be stored in the first capacitor C1. A current may flow from the power line PL to the second node N2 through the fourth transistor T4 turned on in response to the emission signal EM and the first transistor T1, and the voltage of the second node N2 may increase from the initialization voltage VINT to a value VREF-VTH obtained by subtracting the threshold voltage VTH of the first transistor T1 from the reference voltage VREF.

Referring to FIGS. 1, 4, and 8 to 11, in the sensing addressing period PA_S, the sensing data voltage VDAT_S may be applied to the first node N1. The sensing data voltage VDAT_S may be transmitted from the data line DL to the first node N1 through the second transistor T2 turned on in response to the write gate signal GW.

The gate driver 120 may provide write gate signals GW[A], . . . , GW[D] corresponding to the vertical blocks BL[A], BL[B], BL[C], and BL[D], respectively, in the sensing addressing period PA_S. The data driver 140 may provide the sensing data voltage VDAT_S corresponding to a white grayscale (e.g., in which a value of the sensing data voltage VDAT_S corresponds to 255G) to each of the pixel columns PC1, PC2, and PC3 overlapping the sensing area SA. The data driver 140 may provide the sensing data voltage VDAT_S corresponding to a black grayscale (e.g., in which a value of the sensing data voltage VDAT_S corresponds to OG) to each of the pixel columns PC1, PC2, and PC3 not overlapping the sensing area SA in the sensing addressing period PA_S. In an example in which the grayscale range is from 0 grayscale to 255 grayscale, the black grayscale may be 0 grayscale, and the white grayscale may be 255 grayscale.

In the sensing area SA of FIG. 9, the data driver 140 may provide the sensing data voltages VDAT_S corresponding to the black grayscale to the pixel columns PC1, PC2, and PC3 in a period in which the first write gate signal GW[A] has a pulse, a period in which the second write gate signal GW[B] has a pulse, and a period in which the third write gate signal GW[C] has a pulse, and may provide the sensing data voltages VDAT_S corresponding to the white grayscale to the pixel columns PC1, PC2, and PC3 in a period in which the fourth write gate signal GW[D] has a pulse.

In the sensing area SA of FIG. 10, the data driver 140 may provide the sensing data voltages VDAT_S corresponding to the black grayscale to the pixel columns PC1, PC2, and PC3 in a period in which the first write gate signal GW[A] has a pulse, a period in which the second write gate signal GW[B] has a pulse, and a period in which the third write gate signal GW[C] has a pulse, may provide the sensing data voltages VDAT_S corresponding to the black grayscale to the first and third pixel columns PC1 and PC3 in a period in which the fourth write gate signal GW[D] has a pulse, and may provide the sensing data voltages VDAT_S corresponding to the white grayscale to the second pixel columns PC2.

In the sensing area SA of FIG. 11, the data driver 140 may provide the sensing data voltages VDAT_S corresponding to the black grayscale to the pixel columns PC1, PC2, and PC3 in a period in which the first write gate signal GW[A] has a pulse, a period in which the second write gate signal GW[B] has a pulse, and a period in which the fourth write gate signal GW[D] has a pulse, may provide the sensing data voltages VDAT_S corresponding to the black grayscale to the first and second pixel columns PC1 and PC2 in a period in which the third write gate signal GW[C] has a pulse, and may provide the sensing data voltages VDAT_S corresponding to the white grayscale to the third pixel columns PC3.

Referring to FIGS. 4 and 12, the initialization voltage VINT may be applied to the second node N2 in the first sensing bypass period PB1_S. The initialization voltage VINT may be transmitted from the sensing line SL to the second node N2 through the third transistor T3 turned on in response to the initialization gate signal GI. Accordingly, charges stored in the first terminal of the light-emitting element LED may be discharged to the sensing line SL through the third transistor T3. Further, a voltage change of the second node N2 may affect a voltage of the first node N1 by coupling of the first capacitor C1. The voltage of the first node N1 may be a value obtained by adding AV to the sensing data voltage VDAT_S. AV may correspond to a voltage change amount VINT-(VREF-VTH) of the second node N2 and may include the threshold voltage VTH of the first transistor T1.

Referring to FIGS. 4, 13, and 14, the sensing current ISEN corresponding to the sensing data voltage VDAT_S may flow from the power line PL to the sensing line SL in the sensing period PS. The first transistor T1 may generate the sensing current ISEN corresponding to a value VDAT_S+ΔV−VINT−VTH obtained by subtracting the threshold voltage VTH of the first transistor T1 from a voltage difference VDAT_S+ΔV−VINT between the first node N1 and the second node N2 stored in the first capacitor C1, and the sensing current ISEN may flow from the power line PL to the sensing line SL through the fourth transistor T4 turned on in response to the emission signal EM, the first transistor T1, and the third transistor T3 turned on in response to the initialization gate signal GI.

The sensing current ISEN may be based on temperature (e.g., only on temperature) of an area in which the pixel PX including the first transistor T1 is positioned. The sensing current ISEN may correspond to a value VDAT_S+ΔV−VINT−VTH obtained by subtracting the threshold voltage VTH of the first transistor T1 from the voltage difference VDAT_S+ΔV−VINT between the first node N1 and the second node N2, and since ΔV includes the threshold voltage VTH of the first transistor T1, deviation of the threshold voltage VTH of the first transistors T1 of the pixels PX may not affect the sensing current ISEN.

As illustrated in FIG. 14, a sensing voltage VSEN of the sensing line SL may increase from the initialization voltage VINT by the sensing current ISEN in the sensing period PS, and the sensing current ISEN may be calculated based on the increase rate of the sensing voltage VSEN. The sensing current ISEN may be relatively large when the temperature TM_H of the area in which the pixel PX including the first transistor T1 is positioned is relatively high, and the sensing current ISEN may be relatively small when the temperature TM_L of the area which the pixel PX including the first transistor T1 is positioned is relatively low.

The sensing circuit 150 may convert the sensing current ISEN of the sensing area SA of the display panel 110 into the sensing data SD, and may provide the sensing data SD to the controller 160. The controller 160 may accurately estimate the temperature of the sensing area SA of the display panel 110 based on the sensing data SD.

Referring to FIGS. 4 and 15, the initialization voltage VINT may be applied to the second node N2 in the second sensing bypass period PB2_S. The initialization voltage VINT may be transmitted from the sensing line SL to the second node N2 through the third transistor T3 turned on in response to the initialization gate signal GI. Accordingly, charges stored in the first terminal of the light-emitting element LED may be discharged to the sensing line SL through the third transistor T3.

In the present embodiment, since the sensing current ISEN in which the deviation of the threshold voltage VTH of the first transistor T1 is compensated flows to the sensing line SL in the blank period BLK, the sensing current ISEN may be based on the temperature (e.g., only on the temperature) of the area in which the pixel PX including the first transistor T1 is positioned. Accordingly, the temperature of the sensing area SA of the display panel 110 may be accurately estimated through the sensing current ISEN.

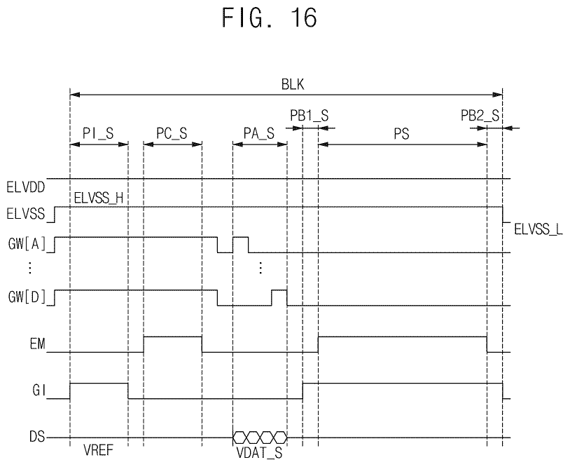

FIG. 16 is a timing diagram illustrating voltages and signals provided to the pixels PX of FIG. 1 in the blank period BLK.

The voltages and the signals described with reference to FIGS. 3 and 16 may be substantially the same as or similar to the voltages and signals described with reference to FIGS. 3 and 4 except for the second power voltage ELVSS.

Referring to FIGS. 3 and 16, in an embodiment, the second power voltage ELVSS may have a low voltage level ELVSS_L in the active period ACT and a high voltage level ELVSS_H higher than the low voltage level ELVSS_L in the blank period BLK. The low voltage level ELVSS_L of the second power voltage ELVSS may be lower than the voltage level of the first power voltage ELVDD, and the high voltage level ELVSS_H of the second power voltage ELVSS may be higher than or equal to the voltage level of the first power voltage ELVDD. Since the second power voltage ELVSS has the high voltage level ELVSS_H in the blanking period BLK, the light-emitting element LED may be prevented from turning on in the sensing period PS.

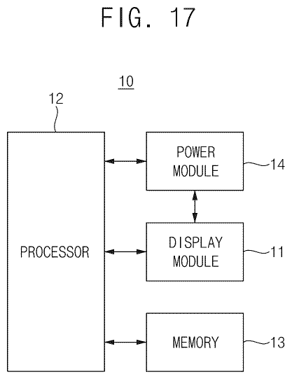

FIG. 17 is a block diagram illustrating an electronic device 10 according to an embodiment.

Referring to FIG. 17, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller. The processor 12 may control the display module 11.

The memory 13 may store data information supportive of an operation of the processor 12 or the display module 11. In an example in which the processor 12 executes an application stored in the memory 13, the input image data IMD1 of FIG. 1 and the control signal CNT0 of FIG. 1 may be transmitted to the display module 11, and the display module 11 may output image information based on the input image data IMD1 and the control signal CNT0.

The power module 14 may include a power supply module such as, for example, a power adapter, a battery device, or the like. and a power conversion module that converts power supplied by the power supply module to generate power supportive of an operation of the electronic device 10.

At least one of the components of the electronic device 10 described herein may be included in the display device 100 of FIG. 1 according to the embodiments described herein. Further, some of individual modules functionally included in one module may be included in the display device 100, and others may be provided separately from the display device 100. For example, the display device 100 may include the display module 11, and the processor 12, the memory 13, and the power module 14 may be provided in the form of other devices within the electronic device 10 other than the display device 100.

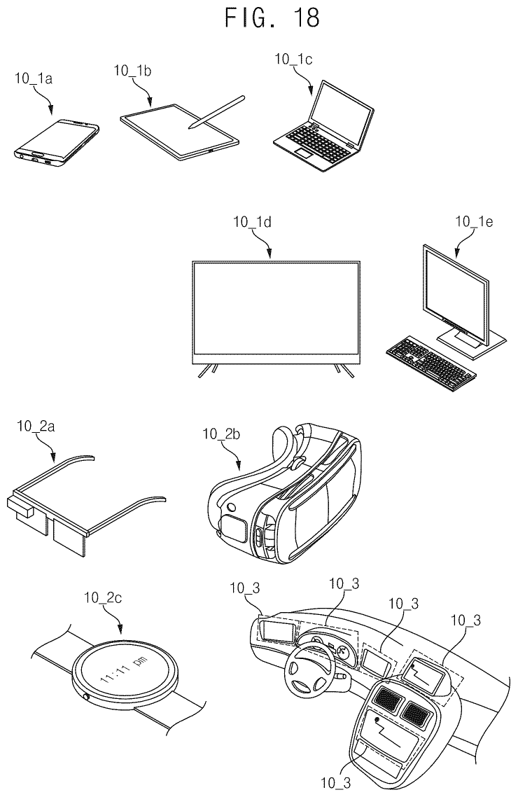

FIG. 18 is a diagram illustrating electronic devices according to embodiments.

Referring to FIG. 18, electronic devices to which display devices according to embodiments are applied may include not only image display electronic devices such as, for example, a smart phone 10_1a, a tablet PC 10_1b, a laptop 10_1c, a TV 10_1d, a desk monitor 10_1e, and the like, but also wearable electronic devices including display modules such as, for example, smart glasses 10_2a, a head mounted display 10_2b, a smart watch 10_2c, etc., vehicle electronic devices 10_3 including display modules such as, for example, an instrument panel of an automobile, a center fascia, a center information display CID arranged on a dashboard, a room mirror display, etc.

The display device according to the embodiments may be applied to a display device included in a computer, a notebook, a mobile phone, a smart phone, a smart pad, a smart watch, a PMP, a PDA, an MP3 player, or the like.

Although the pixel, the display device, and the electronic device according to the embodiments have been described with reference to the drawings, the illustrated embodiments are examples, and may be modified and changed by a person having ordinary knowledge in the relevant technical field without departing from the technical spirit described in the following claims.

What is claimed is:

1. A pixel comprising:
a first transistor comprising a gate connected to a first node, a first terminal, and a second terminal connected to a second node;
a second transistor which connects a data line to the first node in response to a write gate signal;
a third transistor which connects a sensing line to the second node in response to an initialization gate signal;
a fourth transistor which connects a power line to the first terminal of the first transistor in response to an emission signal, wherein the power line transmits a first power voltage;
a first capacitor connected between the first node and the second node; and
a light-emitting element comprising a first terminal connected to the second node and a second terminal which receives a second power voltage, wherein:
a frame period comprises an active period and a blank period following the active period, and
the blank period comprises:
a sensing compensation period in which a threshold voltage of the first transistor is stored in the first capacitor;
a sensing addressing period in which a sensing data voltage is applied to the first node, wherein the sensing addressing period is after the sensing compensation period; and
a sensing period in which a sensing current corresponding to the sensing data voltage flows from the power line to the sensing line, wherein the sensing period is after the sensing addressing period.

2. The pixel of claim 1, wherein the blank period further comprises:
a sensing initialization period in which a reference voltage is applied to the first node and an initialization voltage is applied to the second node, wherein the sensing initialization period is before the sensing compensation period.

3. The pixel of claim 1, wherein the blank period further comprises:
a first sensing bypass period in which an initialization voltage is applied to the second node, wherein the first sensing bypass period is before the sensing period.

4. The pixel of claim 3, wherein the blank period further comprises:
a second sensing bypass period in which the initialization voltage is applied to the second node, wherein the second sensing bypass period is after the sensing period.

5. The pixel of claim 1, further comprising:
a second capacitor comprising a first terminal connected to the second node and a second terminal which receives a constant voltage.

6. The pixel of claim 5, wherein the constant voltage is one of an initialization voltage and the first power voltage.

7. The pixel of claim 1, wherein the second power voltage is a constant voltage having a voltage level lower than a voltage level of the first power voltage.

8. The pixel of claim 1, wherein the second power voltage has a low voltage level in the active period and has a high voltage level higher than the low voltage level in the blank period.

9. The pixel of claim 1, wherein the active period comprises:
an initialization period in which a reference voltage is applied to the first node and an initialization voltage is applied to the second node;
a compensation period in which the threshold voltage of the first transistor is stored in the first capacitor, wherein the compensation period is after the initialization period;
an addressing period in which a data voltage is applied to the first node, wherein the addressing period is after the compensation period;
a bypass period in which the initialization voltage is applied to the second node, wherein the bypass period is after the addressing period; and
an emission period in which a sensing current corresponding to the data voltage flows through the light-emitting element, wherein the emission period is after the bypass period.

10. A display device comprising:
a display panel comprising pixels;
a gate driver which provides a write gate signal and an initialization gate signal to each of the pixels;
an emission driver which provides an emission signal to each of the pixels;
a data driver connected to each of the pixels through a data line; and
a sensing circuit connected to each of the pixels through a sensing line,
wherein:
each of the pixels comprises:
a first transistor comprising a gate connected to a first node, a first terminal, and a second terminal connected to a second node;
a second transistor which connects the data line to the first node in response to the write gate signal;
a third transistor which connects the sensing line to the second node in response to the initialization gate signal;
a fourth transistor which connects a power line to the first terminal of the first transistor in response to the emission signal, wherein the power line transmits a first power voltage;
a first capacitor connected between the first node and the second node; and
a light-emitting element comprising a first terminal connected to the second node and a second terminal which receives a second power voltage,
a frame period comprises an active period and a blank period following the active period, and
the blank period comprises:
a sensing compensation period in which a threshold voltage of the first transistor is stored in the first capacitor;
a sensing addressing period in which a sensing data voltage is applied to the first node, wherein the sensing addressing period is after the sensing compensation period; and
a sensing period in which a sensing current corresponding to the sensing data voltage flows from the power line to the sensing line, wherein the sensing period is after the sensing addressing period.

11. The display device of claim 10, wherein:
the display panel comprises a plurality of vertical blocks each comprising a plurality of pixel rows, and
the gate driver provides write gate signals respectively corresponding to the vertical blocks in the sensing addressing period.

12. The display device of claim 10, wherein the data driver:
provides the sensing data voltage corresponding to a white grayscale to each of pixel columns overlapping a sensing area, and
provides the sensing data voltage corresponding to a black grayscale to each of pixel columns not overlapping the sensing area.

13. The display device of claim 10, wherein the blank period further comprises:
a sensing initialization period in which a reference voltage is applied to the first node and an initialization voltage is applied to the second node, wherein the sensing initialization period is before the sensing compensation period.

14. The display device of claim 10, wherein the blank period further comprises:
a first sensing bypass period in which an initialization voltage is applied to the second node, wherein the first sensing bypass period is before the sensing period.

15. The display device of claim 14, wherein the blank period further comprises:
a second sensing bypass period in which the initialization voltage is applied to the second node, wherein the second sensing bypass period is after the sensing period.

16. The display device of claim 10, wherein each of the pixels further comprises:
a second capacitor comprising a first terminal connected to the second node and a second terminal which receives a constant voltage.

17. The display device of claim 10, wherein the second power voltage is a constant voltage having a voltage level lower than a voltage level of the first power voltage.

18. The display device of claim 10, wherein the second power voltage has a low voltage level in the active period and has a high voltage level higher than the low voltage level in the blank period.

19. The display device of claim 10, wherein the active period comprises:
an initialization period in which a reference voltage is applied to the first node and an initialization voltage is applied to the second node;
a compensation period in which the threshold voltage of the first transistor is stored in the first capacitor, wherein the compensation period is after the initialization period;
an addressing period in which a data voltage is applied to the first node, wherein the addressing period is after the compensation period;
a bypass period in which the initialization voltage is applied to the second node, wherein the bypass period is after the addressing period; and
an emission period in which a sensing current corresponding to the data voltage flows through the light-emitting element, wherein the emission period is after the bypass period.

20. An electronic device comprising:
a processor;
a memory connected to the processor;
a power module connected to the processor; and
a display device which receives input image data from the processor, and displays an image corresponding to the input image data, the display device comprising:
a display panel comprising pixels;
a gate driver which provides a write gate signal and an initialization gate signal to each of the pixels;
an emission driver which provides an emission signal to each of the pixels;
a data driver connected to each of the pixels through a data line; and
a sensing circuit connected to each of the pixels through a sensing line, wherein:
each of the pixels comprises:
a first transistor comprising a gate connected to a first node, a first terminal, and a second terminal connected to a second node;
a second transistor which connects the data line to the first node in response to the write gate signal;
a third transistor which connects the sensing line to the second node in response to the initialization gate signal;
a fourth transistor which connects a power line to the first terminal of the first transistor in response to the emission signal, wherein the power line transmits a first power voltage;
a first capacitor connected between the first node and the second node; and
a light-emitting element comprising a first terminal connected to the second node and a second terminal which receives a second power voltage,
a frame period comprises an active period and a blank period following the active period, and
the blank period comprises:
a sensing compensation period in which a threshold voltage of the first transistor is stored in the first capacitor;
a sensing addressing period in which a sensing data voltage is applied to the first node, wherein the sensing addressing period is after the sensing compensation period; and
a sensing period in which a sensing current corresponding to the sensing data voltage flows from the power line to the sensing line, wherein the sensing period is after the sensing addressing period.
